(19) United States
(12) Patent Application Publication
(10) Pub. No.: US 2023/0421010 A1
(43) Pub. Date: Dec. 28, 2023

(54) STATOR FOR AN ELECTRIC MACHINE, AND ELECTRIC MACHINE

(71) Applicant: VALEO SIEMENS EAUTOMOTIVE GERMANY GMBH, Erlangen (DE)

(72) Inventor: Boris DOTZ, Bad Neustadt a.d.Saale (DE)

(73) Assignee: Valeo eAutomotive Germany GmbH, Erlangen (DE)

(21) Appl. No.: 18/250,676

(22) PCT Filed: Sep. 22, 2021
(86) PCT No.: PCT/EP2021/076109

§ 371 Date: Apr. 26, 2023

(30) Foreign Application Priority Data
Oct. 29, 2020 (DE) 10 2020 213 647.5

(51) Int. Cl. H02K 3/28; H02K 1/16

(52) U.S. Cl. CPC H02K 3/28; H02K 1/16

(57) ABSTRACT

Stator for an electric machine has a number N of phases (U, V, W), a number P of pole pairs and a number of holes q, wherein N≥3 and P≥2 and q=3. The stator includes a stator core having a plurality of slots and a plurality of shaped conductors, which are arranged in the slots so as to be radially layered in a first to Lth layer, wherein L=6. The shaped conductors of each phase form a first path and second path, which can be or are interconnected in series or in parallel with each other and are arranged in P first winding zones and P second winding zones, wherein the first and second winding zones alternate in the circumferential direction. The shaped conductors of a respective path are interconnected to form a series connection by connectors.

The present invention relates to a stator for an electric machine. In addition, the invention relates to an electric machine for driving a vehicle.

Stators with a stator winding formed from shaped conductors are extremely popular particularly in automotive applications since they are particularly suitable for automated manufacture with a high degree of process reliability and simple connection options for the phases. A high-quality rotating field during operation of the electric machine with small harmonics and resistive losses in the stator winding is desirable. To this end, in a stator with N=3 phases, L=6 layers per slot and a number of holes q=3, two layers of winding zones of the stator should be offset in the circumferential direction by one slot.

In this regard, for example, CN 109 038 878 A discloses a three-phase stator for a motor, comprising a stator core and a plurality of stator slots in the stator core, wherein stator windings are arranged in the plurality of stator slots in six layers. The number of stator slots per pole and phase is three. A respective set of stator windings occupies a pair of mutually adjacent positions of the stator slots, wherein two sets of stator windings are offset by one stator slot. A respective phase winding of the stator is divided into two paths, which are connected in series or in parallel.

As a result of such a chorded stator, in particular when using rotors with axially linear poles, torque ripples can be effectively reduced, which leads to quieter operation in terms of noise vibration harshness (NVH).

The invention is based on the object of specifying an improved way of operating a chorded stator having a stator winding formed from shaped conductors.

This object is achieved according to the invention by a stator for an electric machine, wherein the stator has a number N of phases, a number P of pole pairs and a number of holes q, wherein N≥3 and P≥2 and q=3, wherein the stator comprises a stator core having a plurality of slots and a plurality of shaped conductors, which are arranged in the slots so as to be radially layered in a first to Lth layer, wherein L=6 and the layers are numbered in their order in the radial direction, wherein the shaped conductors of each phase form a first path and a second path, which can be or are interconnected in series or in parallel with each other, and are arranged in P first winding zones and P second winding zones, wherein the first and second winding zones alternate in the circumferential direction and each winding zone extends over the L layers, wherein a first orientation and a second orientation—which is opposed to the first orientation—of the circumferential directions are defined, wherein the shaped conductors of a respective path are interconnected to form a series connection having a first outer shaped conductor in terms of the series connection and a second outer conductor in terms of the series connection by connectors which connect shaped conductors in adjacent winding zones of the same phase in an alternating manner at a first end side and a second end side—opposite the first end side—of the stator core, wherein the first and second layer of a respective winding zone are offset with respect to the third and fourth layer of the respective winding zone by one slot in the circumferential direction, wherein the paths each form a combined lap and wave winding.

The stator according to the invention is notable in that it has a chording due to the offset of the layers of the winding zones so that two phases are positioned in at least one slot with a conductor ratio of 2/4. In this way, the efficiency, the occurrence of torque ripples and harmonics and the occurrence of noise and vibrations can be noticeably reduced in comparison to stators with winding zones, which each extend over precisely q slots and are therefore unchorded. At the same time, there is a significant increase in the number of different connector/conductor combinations, which significantly increases the production-friendliness of the stator according to the invention.

The number of holes q is the number of slots per pole and phase of the stator. In the stator according to the invention, N can be ≤12, preferably, N can be ≤9, particularly preferably, N can be ≤6. Provision may be made for P to be ≤20, preferably for P to be ≤16, particularly preferably for P to be ≤12. The number of slots is preferably less than 200, particularly preferably less than 120. The number of slots can be precisely 2·P·N·q. Precisely 2·P·N·q·L shaped conductors can be provided. Each winding zone preferably realizes one pole of the stator.

Precisely one winding zone of the other phases is expediently located between each pair of adjacent winding zones of a phase in each case. In other words, each pair of adjacent winding zones of a phase is spaced apart by q·(N−1) slots. The stator is preferably designed so that current flows through the first windings zones in a direction of flow which is which is opposed to the direction of flow of the second winding zones.

In a preferred refinement, provision is made for precisely six shaped conductors to be received in each slot and/or for N to be precisely 3 and/or for P to be precisely 2, 3 or 4 and/or for q to be precisely 3. The first layer is preferably the radially innermost layer and/or the sixth layer is preferably the radially outermost layer. However, it is also conceivable for the first layer to be the radially outermost layer and/or the sixth layer to be the radially innermost layer.

The shaped conductors can be rod-like conductors, in particular composed of copper. The shaped conductors are typically not flexurally slack. Four shaped conductors in the six layers and/or in the entire slot preferably take up at least 60%, preferably at least 80%, of the cross-sectional area of a slot. The shaped conductors preferably have a, possibly also rounded, rectangular cross section. Each shaped conductor can extend through one of the slots completely in the axial direction.

A “path” is intended to be understood to mean a series connection of shaped conductors realized by the connectors, which series connection can also be referred to as a “current path”. Each path preferably comprises precisely P·q·L shaped conductors.

The stator core can be formed by a plurality of permanently connected individual laminations layered with each other. In particular, the stator core forms a laminated core. Each slot preferably extends parallel to a center axis along which a receiving space, surrounded by the stator core, for a rotor extends. The first orientation preferably corresponds to the clockwise direction, as seen from the first end side.

In a preferred refinement of the stator according to the invention, provision is made for the first outer shaped conductor of the first path to be arranged in one of the first winding zones and the first outer shaped conductor of the second path to be arranged in one of the first winding zones. The first outer shaped conductor of the second path is particularly preferably arranged in the same first winding zone in which the first outer shaped conductor of the first path is arranged. In this way, connections of the two paths can be formed in a particularly space- and material-saving manner to establish their series or parallel connection.

In general, in the stator according to the invention, provision can be made for each path to be subdivided into q series-connected arrangements of series-connected shaped conductors. Each arrangement here can occupy all winding zones of the phase q times. In other words, each arrangement extends about the stator core once in the circumferential direction. A respective path or the arrangements can therefore have q turns about the stator core in the circumferential direction. Each arrangement typically comprises the same number of shaped conductors.

In the stator according to the invention, provision can further be made for each winding zone to be subdivided into a first to qth sub-winding zone, for each sub-winding zone to extend over the L layers and for the sub-winding zones of a respective winding zone to be numbered in their order in the circumferential direction. Each sub-winding zone here can comprise precisely L receiving spaces of a total of q·L connected receiving spaces for precisely one shaped conductor in each case. The first sub-winding zone and the third sub-winding zone here can comprise the outer receiving spaces in the circumferential direction and the second sub-winding zone can comprise the center receiving spaces in the circumferential direction. The first sub-winding zone preferably follows the first orientation and the third sub-winding zone preferably follows the second orientation.

In an advantageous refinement, provision is made for the shaped conductors of a respective arrangement to be arranged in the same sub-winding zone. The sub-winding zones can thus be successively occupied by a respective arrangement during one turn.

Provision is preferably made for the first outer shaped conductor of a respective path to be arranged in the first sub-winding zone and/or for the second outer shaped conductor of a respective path to be arranged in the third sub-winding zone. The paths can thus occupy the sub-winding zones along one orientation from turn to turn.

In the stator according to the invention, it is particularly preferred if the first path extends from its first outer shaped conductor to its second outer shaped conductor along the first orientation and the second path extends from its first outer shaped conductor to its second outer shaped conductor along the second orientation. In other words, the first path and the second path extend in opposite directions about the stator core in the circumferential direction.

In a preferred refinement of the stator according to the invention, it is provided that the lap windings of the first path are formed in a pair of adjacent winding zones in which two adjacent lap windings of the second path are connected by a wave winding. The available space for the connectors at the end sides can thus be used highly efficiently so that a compact winding overhang is realized.

In the stator according to the invention, the first and second layer of a respective winding zone are preferably offset along the first or second orientation with respect to the third and fourth layer. It is also conceivable that the first and second layer of a respective winding zone are offset with respect to the third and fourth layer along the second orientation.

In the stator according to the invention, it is further preferred if the fifth and sixth layer of a respective winding zone are offset with respect to the third and fourth layer of the respective winding zone by one slot in the circumferential direction. In such a double chorded stator, two phases are positioned in two slots each with a conductor ratio 2/4. Detent torques and torque ripples can thus be further reduced. The fifth and sixth layer are particularly preferably offset in the contrary orientation to the offset of the first and second layer. The winding zones then have a stepped form, figuratively speaking.

In the stator according to the invention, it is further preferred if the first path is formed from a plurality of series-connected groups of six successive shaped conductors, in terms of the series connection, which are arranged in one of the first winding zones and a second winding zone adjacent thereto along the first orientation. The first path preferably comprises P·q groups or each arrangement comprises P groups.

In an advantageous refinement here, a first shaped conductor of a respective one of the groups can be arranged in the fifth layer of the first winding zone, a second shaped conductor of a respective one of the groups can be arranged in the sixth layer of the second winding zone, a third shaped conductor of a respective one of the groups can be arranged in the fourth layer of the first winding zone, a fourth shaped conductor of a respective one of the groups can be arranged in the third layer of the second winding zone, a fifth shaped conductor of a respective one of the groups can be arranged in the first layer of the first winding zone and a sixth shaped conductor of a respective one of the groups can be arranged in the second layer of the second winding zone, wherein the first shaped conductor to the sixth shaped conductor are numbered in their order in terms of the series connection. In this way, each group forms two loops of the lap winding. In this refinement, the odd-numbered shaped conductors and the even-numbered shaped conductors following them are always arranged in the outer, center or inner pair of layers. This results in the connector, which joins these shaped conductors not having to jump the offset between the layers by one slot. This realizes a uniform offset of q·N slots. The offset, which is realized by a connector which connects the one even-numbered shaped conductor to an odd-numbered shaped conductor of the same group can, however, deviate from q·N by one, in particular q·N−1.

It is further preferred if the first shaped conductor of such groups which directly follow a sixth shaped conductor of another of the groups in terms of the series connection is arranged in that first winding zone which follows the sixth shaped conductor of the other of the groups along the first orientation. The connector, which connects the sixth and first shaped conductor, thus realizes the wave component of the combined wave and lap winding. Connectors, which connect the sixth and first shaped conductor of groups of the same arrangement preferably, realize an offset of q·N−1 or, in particular in a double chorded stator, q·N−2 slots. Connectors, which connect the sixth and first shaped conductor of groups of different arrangements preferably, realize an offset of q·N−2 or, in particular in a double chorded stator, q·N−3 slots. Compared to unchorded or linear stators, it is possible to save on conductor material for the connectors as a result of this reduction in the offsets.

In the stator according to the invention, it is further preferred if the second path is formed from a plurality of series-connected groups of six successive shaped conductors, in terms of the series connection, which are arranged in four of the first winding zones. Typically, the second path comprises P·q groups or each arrangement comprises P groups.

In an advantageous refinement here, a first shaped conductor of a respective one of the groups can be arranged in the sixth layer of one of the first winding zones, a second shaped conductor of a respective one of the groups can be arranged in the fifth layer of a following second winding zone along the second orientation, a third shaped conductor of a respective one of the groups can be arranged in the second layer of a following first winding zone along the second orientation, a fourth shaped conductor of a respective one of the groups can be arranged in the first layer of a following second winding zone along the second orientation, a fifth shaped conductor of a respective one of the groups can be arranged in the third layer in the same first winding zone as the third shaped conductor and a sixth shaped conductor of a respective one of the groups can be arranged in the fourth layer in the same second winding zone as the fourth shaped conductor, wherein the first shaped conductor to the sixth shaped conductor are numbered in their order in terms of the series connection. The connector connecting the second and third shaped conductor here can form the wave component of the combined lap and wave winding. In this refinement, the odd-numbered shaped conductors and the even-numbered shaped conductors following them are always arranged in the outer, center or inner pair of layers. This results in the connector which connects these shaped conductors not having to jump the offset between the layers by one slot, thus realizing a uniform offset of q·N slots. The offset which is realized by a connector which connects an even-numbered shaped conductor to an odd-numbered shaped conductor can, however, be smaller than q·N, in particular q·N−1 or q·N−2.

It is further preferred if the first shaped conductor of such groups which directly follow a sixth shaped conductor of another of the groups in terms of the series connection is arranged in the same first winding zone as the fifth shaped conductor of the other of the groups. In this way, each pair of two adjacent groups of the second path form two loops of the lap winding. Connectors which connect the sixth and first shaped conductor of groups of the same arrangement preferably realize an offset of q·N or, in particular in a double chorded stator, q·N−1 slots. Connectors which connect the sixth and first shaped conductor of groups of different arrangements preferably realize an offset of q·N−1 or, in particular in a double chorded stator, q·N−2 slots. Compared to unchorded or linear stators, it is possible to save on conductor material for the connectors as a result of this reduction in the offsets.

The groups of the first path can also be referred to as groups of a first type and the groups of the second path can also be referred to as groups of a second type.

In the stator according to the invention, provision can moreover advantageously be made for the connectors to be alternately formed as connectors of the first type, which are arranged at a first end side of the stator core, and as connectors of the second type, which are arranged at a second end side—opposite the first end side—of the stator core. The first and second outer shaped conductors of a respective path are preferably connected to the adjacent shaped connector in terms of the series connection by connectors of the second type. In particular, the outer shaped conductors can thus be contacted or connected at the end side on which the connectors of the first type are located.

In a preferred refinement, provision is made here for the connectors of the first type to be formed in one piece with the shaped conductors connected by them and to extend out of the stator core at the first end side. The connectors of the first type and the shaped conductors connected by them are preferably formed from an electrically conductive rod, wherein the connector of the first type is formed, in particular, by bending the rod.

A respective first connector, the shaped conductors connected by it and the connecting elements, adjoining the shaped conductors, of two second connectors can consequently form a one-piece conductor segment which can also be referred to as a hairpin conductor or U-pin.

As an alternative or in addition, provision can be made for the connectors of the second type to comprise two connecting elements which adjoin the shaped conductors, connected by the connector of the second type, at the second end side in a manner extending out of the stator core and for them to be electrically conductively connected to each other, in particular in an integrally bonded manner. The shaped conductors and the connecting elements adjoining them can also be formed from the or an electrically conductive rod, wherein the connecting elements are formed, in particular, by bending the rod after insertion into the stator core.

The connectors of the second type preferably connect pairs of directly successive shaped conductors, in terms of the series connection, in the first layer and the second layer and/or in the third layer and the fourth layer and/or in the fifth layer and the sixth layer. As already described for the detailed refinement via the first and second groups, this generally enables a way for the connectors of the second type to be configured such that they do not have to jump the offset between layers within the winding zones and can therefore be configured in a uniform manner. This is particularly favourable if the connectors of the second type are formed by the mutually connected connecting elements.

In the case of the stator according to the invention, it is moreover preferred if this further comprises a connection device with phase connections and at least one star point. The stator can be supplied with electrical power by means of such connection devices in order to form a magnetic rotating field.

According to a preferred first refinement, the connection device connects the paths of a respective phase in parallel such that the first outer shaped conductors are connected to the phase connections and the second outer shaped conductors are connected to form a star point or two star points such that the second outer shaped conductors are connected to the phase connections and the first outer shaped conductors are connected to form a star point or two star points. According to a preferred second refinement, the connection device connects the paths of a respective phase in series such that one of the outer shaped conductors of one of the paths is connected to the phase connections and one of the outer shaped conductors of the other of the paths is connected to the star point.

A connection element preferably adjoins the first outer shaped conductor and/or the second outer shaped conductor at the first end side and a connecting element of a connector of the second type preferably adjoins the first outer shaped conductor and/or the second outer shaped conductor at the second end side. Such an arrangement can also be referred to as an I pin. The connection element preferably extends further in the axial direction than the connectors of the first type. The connection elements are preferably contacted by the connection device.

The object on which the invention is based is further achieved by an electric machine for driving a vehicle, comprising a stator as claimed in any of the claims and a rotor rotatably mounted within the stator. The electric machine is preferably an electric motor. The electric machine can be, for example, a synchronous machine with permanent excitation or a synchronous motor with permanent excitation or an asynchronous machine/induction machine or an asynchronous motor.

Further advantages and details of the present invention can be gathered from the exemplary embodiments described below and on the basis of the drawings. The drawings are schematic illustrations in which:

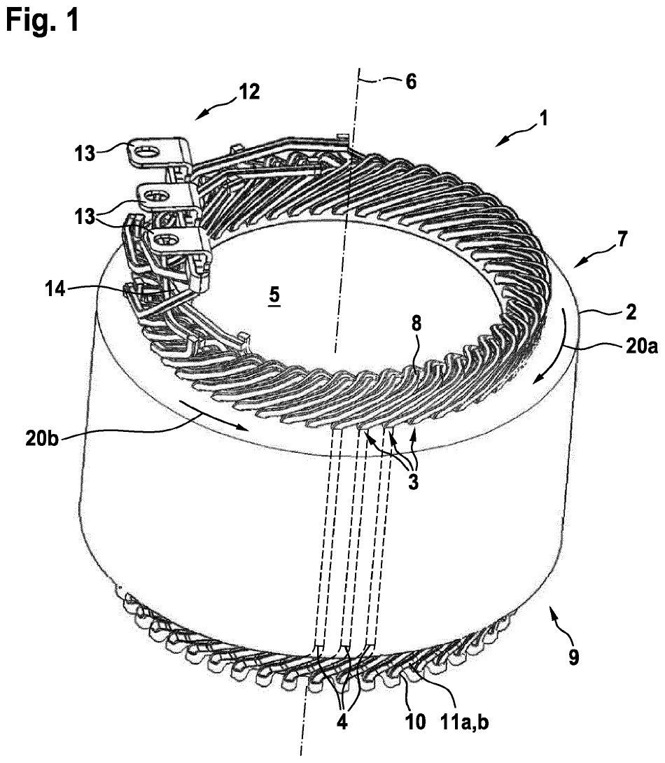

FIG. 1 shows a basic diagram of a stator;

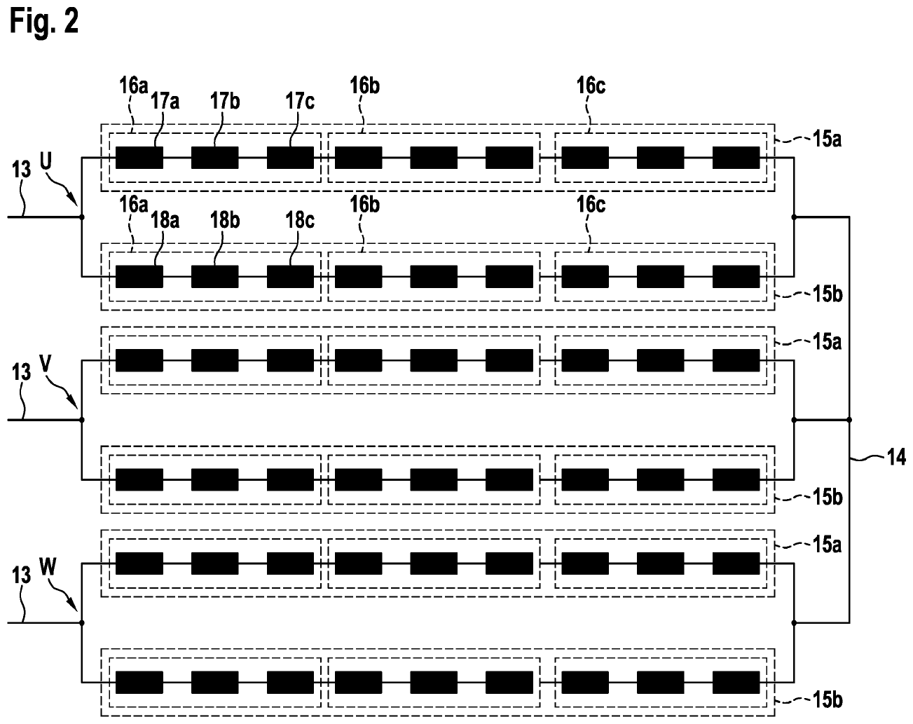

FIG. 2 shows a block circuit diagram of the stator winding of a first exemplary embodiment of the stator according to the invention;

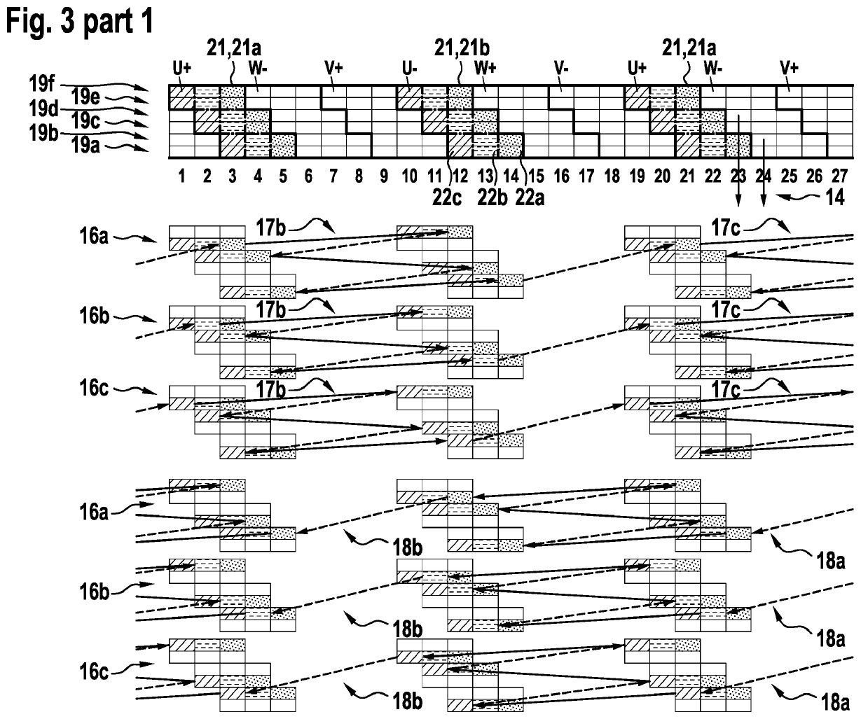

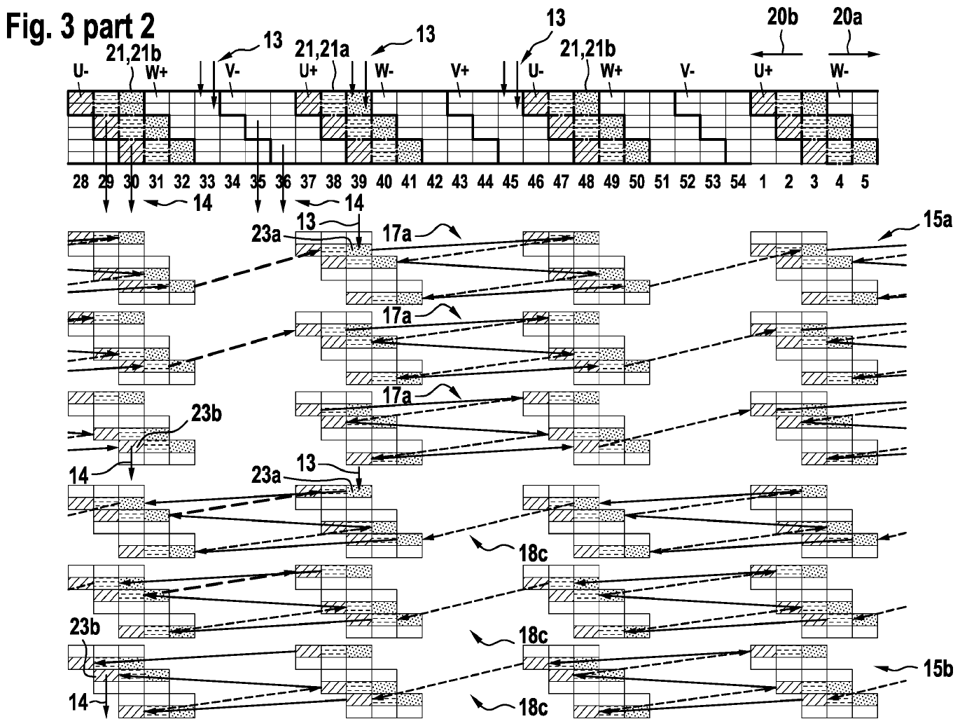

FIG. 3 shows a winding diagram according to the first exemplary embodiment;

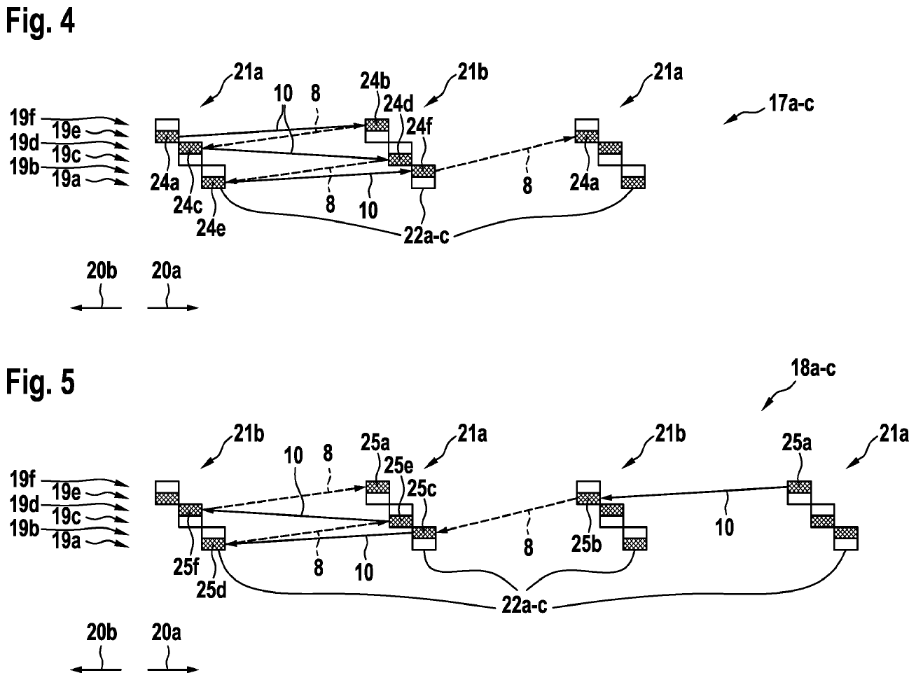

FIG. 4 shows the sub-winding diagram of the groups of the first type according to the first exemplary embodiment;

FIG. 5 shows the sub-winding diagram of the groups of the second type according to the first exemplary embodiment;

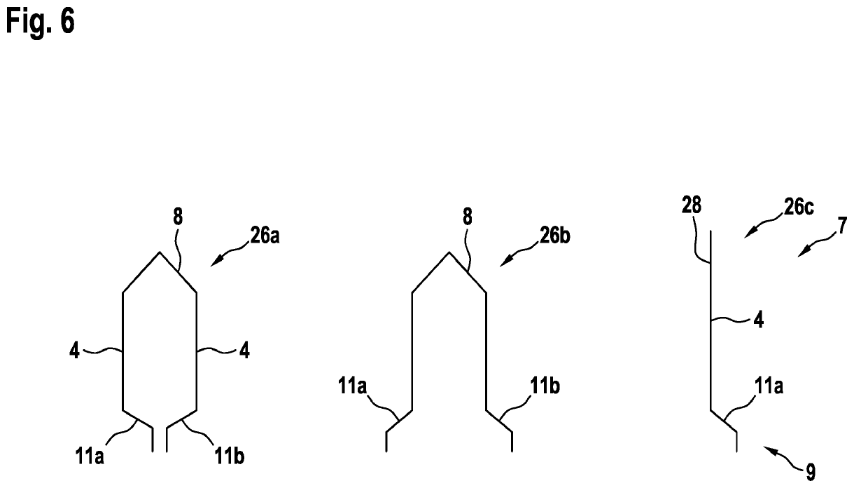

FIG. 6 shows a basic diagram of a plurality of conductor segments according to the first exemplary embodiment;

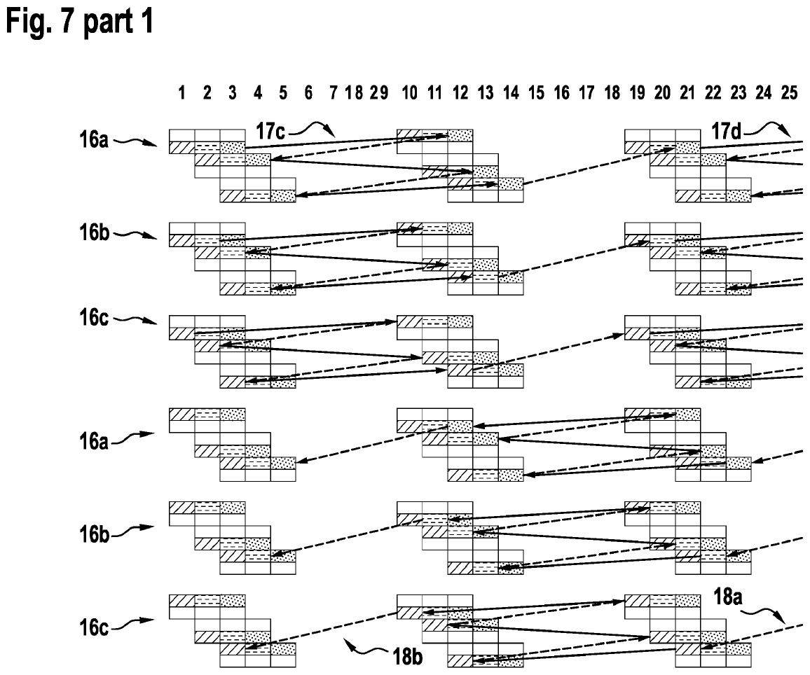

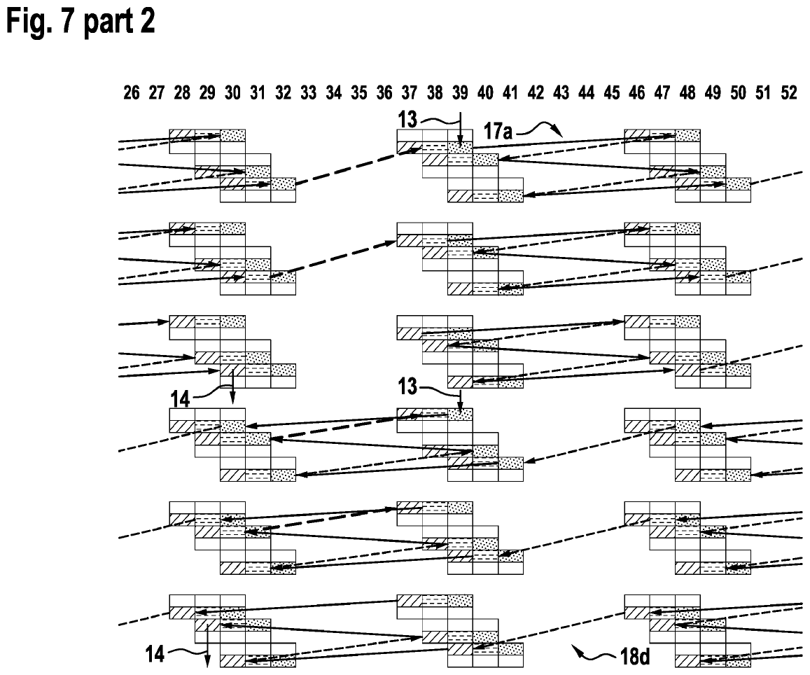

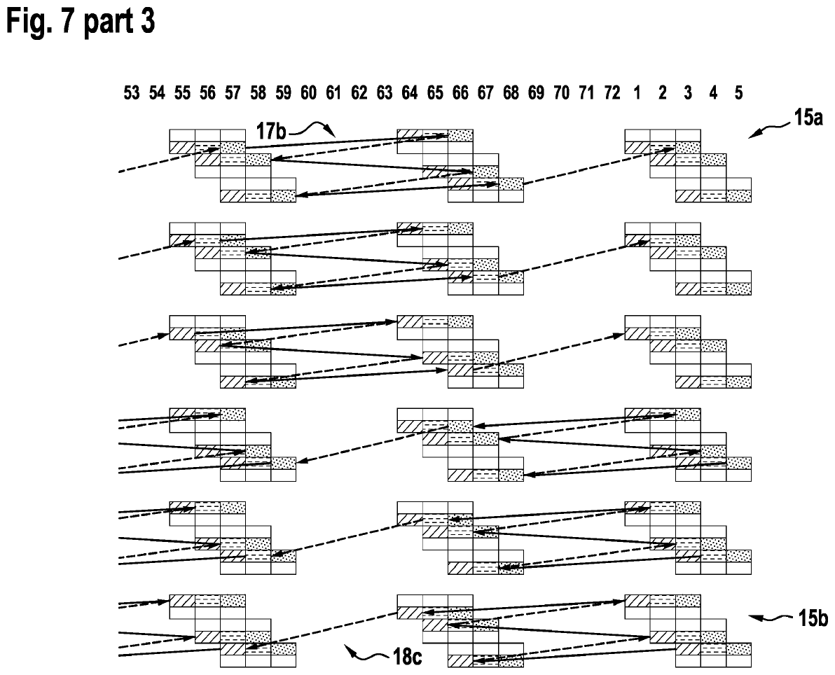

FIG. 7 shows a winding diagram according to a second exemplary embodiment of the stator according to the invention;

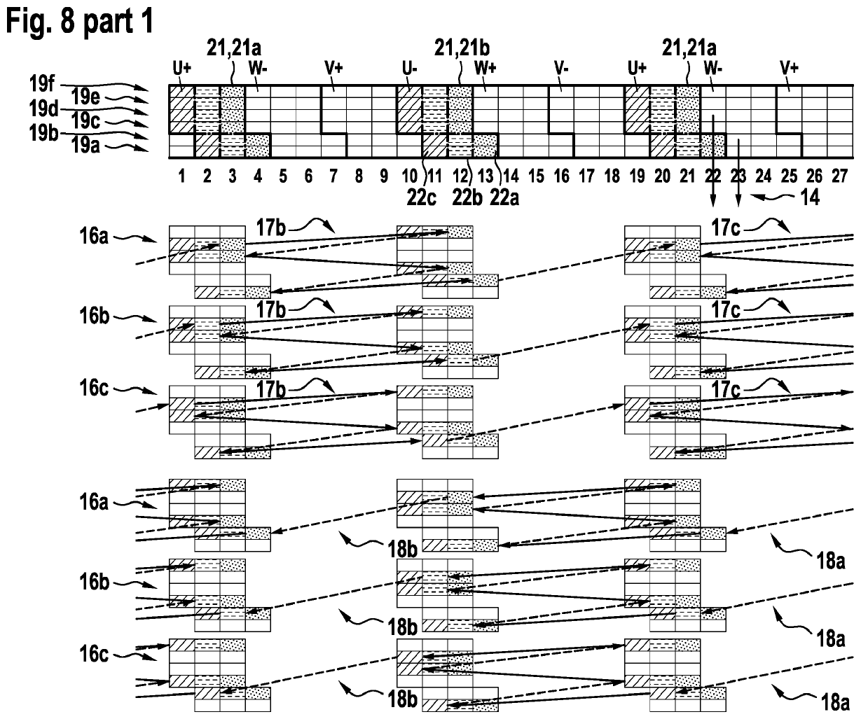

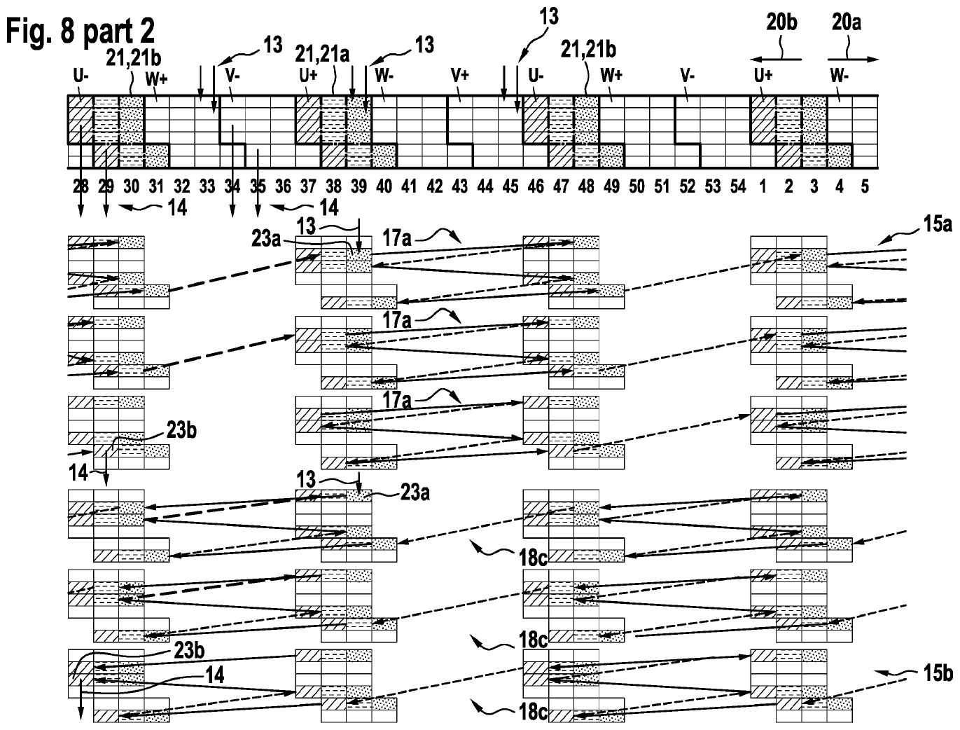

FIG. 8 shows a winding diagram according to a third exemplary embodiment of the stator according to the invention;

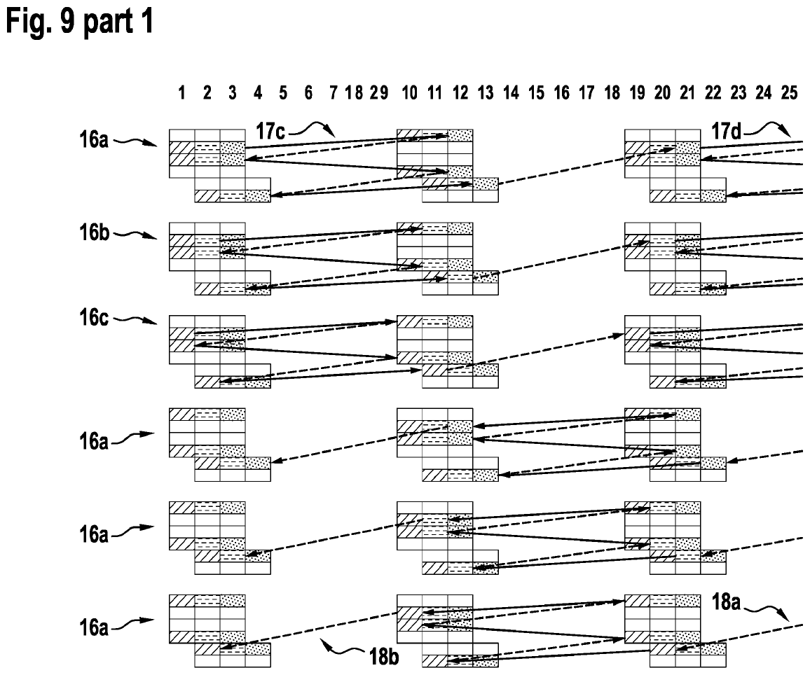

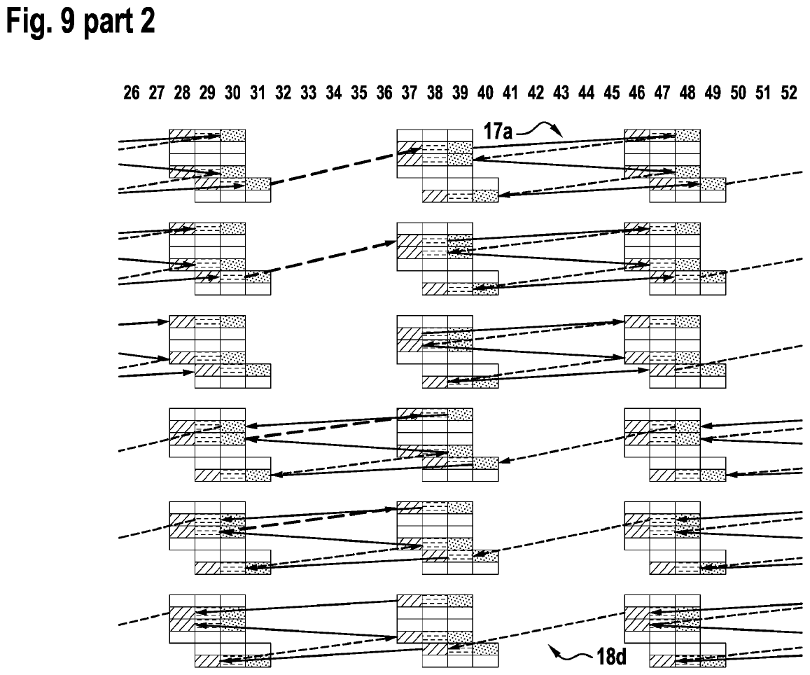

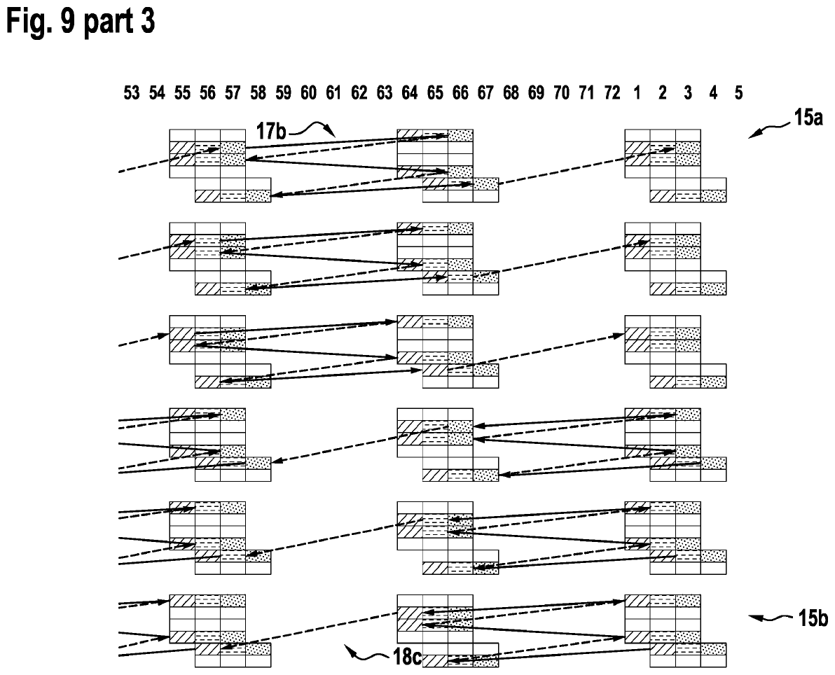

FIG. 9 shows a winding diagram according to a fourth exemplary embodiment of the stator according to the invention;

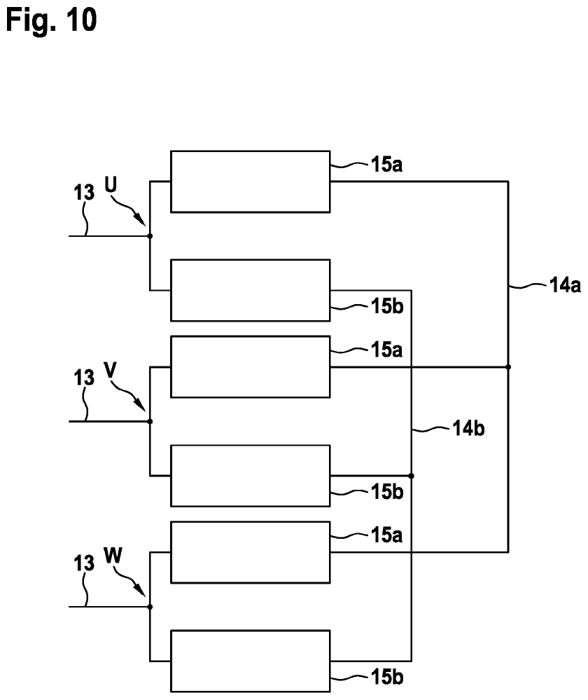

FIG. 10 shows a block circuit diagram of the stator winding according to further exemplary embodiments of the stator according to the invention;

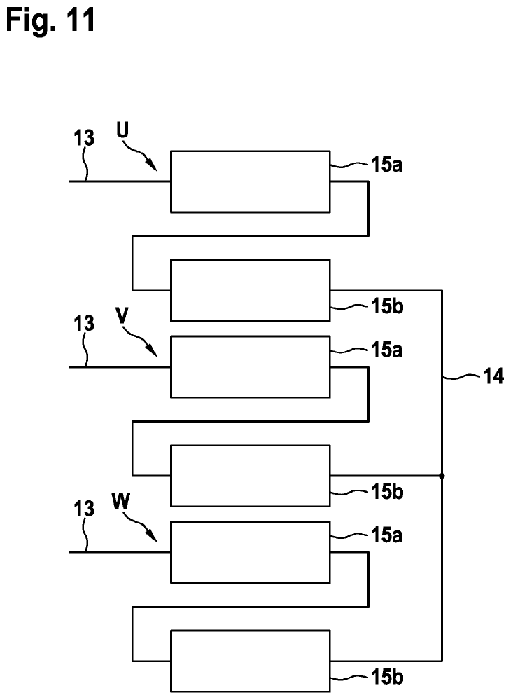

FIG. 11 shows a block circuit diagram of the stator winding according to further exemplary embodiments of the stator according to the invention;

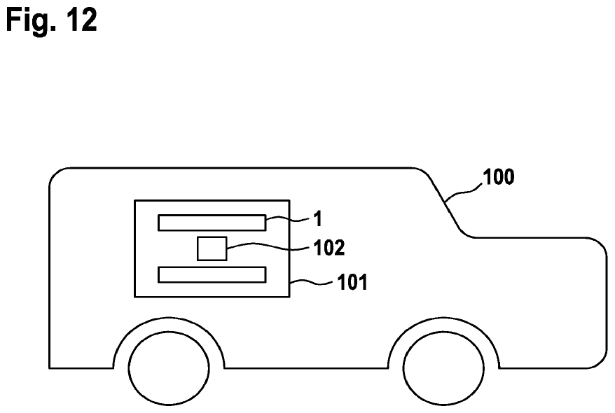

FIG. 12 shows a basic diagram of a vehicle having an exemplary embodiment of the electric machine according to the invention.

FIG. 1 is a basic diagram of a stator 1.

The stator 1 has a stator core 2, which has a plurality of slots 3 formed in a circumferential direction. In addition, the stator 1 has a plurality of shaped conductors 4, which are arranged in the slots 3 in a layered manner. The shaped conductors 4 extend through the slots 3 completely in the axial direction, that is to say parallel to a center axis 6 passing through a receiving space 5 for a rotor.

At a first end side 7 of the stator 1, the shaped conductors 4 are connected in pairs by connectors of the first type 8. The connectors of the first type 8 are formed in one piece with the pair of shaped conductors 4 here and realize bending through 180°. At a second end side 9 of the stator 1, the shaped conductors 4 are connected in pairs by connectors of the second type 10. The connectors of the second type 10 comprise two bent connecting elements 11a, 11b which adjoin the connected shaped conductors 4 in one piece and are connected to each other. Here, the connection is formed in an integrally bonded manner, in particular by welding. The shaped conductors 4 and the connectors 8, 10 form a stator winding of the stator 1.

FIG. 1 further shows a connection device 12, which forms phase connections 13 and a star point 14 or a plurality of star points of the stator winding.

FIG. 2 shows a block circuit diagram of a stator winding according to a first exemplary embodiment of a stator 1, to which the statements made in relation to the stator 1 shown in FIG. 1 can be applied.

The stator 1 according to the first exemplary embodiment has, in the exemplary configuration shown, N=3 phases U, V, W, P=3 pole pairs and a number of holes 1=3. The shaped conductors 4 form a first path 15a and a second path 15b for each phase U, V, W. The paths 15a, 15b of a respective phase U, V, W are connected in parallel by means of the connection device 12. The shaped conductors 4 of a respective path 15a, 15b are connected in series. By means of the connection device 12, the parallel-connected paths 15a, 15b of a respective phase U, V, W are connected to the phase connections 13 on the one hand and interconnected to form the star point 14 on the other.

Each path 15a, 15b has q=3 arrangements 16a-c of series-connected shaped conductors 4. The arrangements 16a-c of the first path 15a are each formed from P=3 groups of the first type 17a-c of the series-connected shaped conductors 4. The arrangements 16a-c of the second path 15b are each formed from P=3 groups of the second type 18a-c of the series-connected shaped conductors 4.

FIG. 3 shows a winding diagram of the stator winding according to the first exemplary embodiment.

The stator core has a total number of 2·P·N·q=54 slots 3. The number of holes q therefore describes the ratio of the number of slots 3 to the product of the number of poles 2·P and the number of phases N.

The shaped conductors 4 here are arranged in a first layer 19a, a second layer 19b, a third layer 19c, a fourth layer 19d, a fifth layer 19e and a sixth layer 19f, wherein the layers 19a-f are numbered in accordance with their order from radially on the inside to radially on the outside. Consequently, the first layer 19a is the radially innermost layer and the sixth layer 19f is the radially outermost layer of the six layers 19a-f. Precisely one shaped conductor 4 is arranged in each layer 19a-f of a respective slot 3. In other words, each layer 19a-f of a respective slot 3 forms a receiving space for precisely one shaped conductor 4. This results in a number of, in total, 2·P·N·q·L=324 receiving spaces or shaped conductors 4 of the stator 1, wherein L describes the number of layers 19a-f.

FIG. 3 shows, using two arrows arranged above the upper table, a first orientation 20a of the circumferential direction, which orientation corresponds to the clockwise direction as seen from the first end side 7 of the stator 1, and a second orientation 20b, which corresponds to the anti-clockwise direction as viewed from the first end side 7 of the stator 1, (also see FIG. 1). FIG. 3 further shows slot numbering from 1 to 54 below the upper table. The upper table in FIG. 3 shows which phase U, V, W a shaped conductor 4 arranged in a respective receiving space belongs to, where the addition of a “+” or “−” denotes a direction of flow of an electric current through the shaped conductor 4 in question. It is clear that the shaped conductors of each phase U, V, W are arranged in 2·P=6 winding zones 21 which each comprise precisely q·L=18 receiving spaces.

In the present exemplary embodiment, each winding zone 21 extends radially over the six layers 19a-f. The winding zones 21 are notable in that the first layer 19a and the second layer 19b are offset with respect to the third layer 19c and the fourth layer 19d by one slot 3 along the first orientation 20a in the circumferential direction and in that the fifth layer 19e and the sixth layer 19f are offset with respect to the third layer 19c and the fourth layer 19d by one slot along the second orientation 20b in the circumferential direction. Each winding zone 21 therefore extends over precisely q+2=5 directly adjacent slots 3 in the circumferential direction. The winding zones 21 are further divided into first winding zones 21 and second winding zones 21b, which alternate in the circumferential direction and through which current flows in contrary directions, as denoted by the designations U+, U−, V+, V−, W+, W− for a respective phase U, V, W.

The winding zones 21 are in turn subdivided into a first sub-winding zone 22a, into a second sub-winding zone 22b and into a second sub-winding zone 22c, which are identified using different hatching styles in FIG. 3 and extend over all six layers 18a-d in each case. The first sub-winding zone 22a here comprises the first receiving spaces of the winding zone 21, as seen from the first orientation 20b, the second sub-winding zone 22b comprises the center receiving spaces immediately adjacent to the receiving spaces of the first sub-winding zone 22a and the third sub-winding zone 22c comprises the outer receiving spaces immediately adjacent to the receiving spaces of the second sub-winding zone 22b.

Below the slot numbering, FIG. 3 shows the receiving spaces, occupied by shaped conductors 4 of the phase U, in the winding zones 21, separately for each arrangement 16a-c of the first path 15a and the second path 15b. Shaped conductors 4 here are identified by hatching the receiving space occupied by them. Connectors of the first type 8, which connect two shaped conductors 4 in two different receiving spaces, are identified by dashed arrows between the two receiving spaces, and connectors 10 of the second type, which connect two shaped conductors 4 in two different receiving spaces, are identified by solid arrows between the two receiving spaces. The illustration of the shaped conductors 4 and the connectors 8, 10 for the phase U here is representative of the other phases V, W in which the arrangement of the shaped conductors 4 and connectors 8, 10, apart from a shift by q=3 slots 3 in the circumferential direction, corresponds to that of phase U.

The winding diagram of the stator according to the first embodiment is explained in more detail below with reference to the phase U, wherein the embodiments can be applied accordingly to the other phases V, W. To this end, at the top of FIG. 3, those receiving spaces for shaped conductors 4, which are connected to the phase connections 13 and the star point 14 in the block circuit diagram according to FIG. 2, are identified accordingly for all phases U, V. W.

The stator winding of the stator 1 forms a combined lap and wave winding. The first path 15a and the second path 15b here extend in opposite directions about the stator core 2, wherein the first path 15a extends along the first orientation 20a and the second path 15b extends along the second orientation 20b.

The first outer shaped conductor 23a of the first path 15a, in terms of the series connection and the first outer shaped conductor 23a of the second path 15b, in terms of the series connection, are arranged in the same first winding zone 21a. In the present exemplary embodiment, the first outer shaped conductor 23a of both paths 15a, 15b is arranged in directly adjacent layers 19e, 19f of the same slot 3. The second outer shaped conductor 23b of the first path 15a, in terms of the series connection, and the second outer shaped conductor 23b of the second path 15b, in terms of the series connection, are arranged in the same second winding zone 21b.

As can be gathered from FIG. 3, each arrangement 16a realizes a complete turn about the stator core 2. In other words, all arrangements 16a-c of both paths 15a, 15b start in the same first winding zone 21a and end in the same second winding zone 21b. Each arrangement 16a-c here occupies all winding zones 21 of the phase U precisely q-times, that is to say three times. The shaped conductors 4 of the first arrangement 16a of a respective path 15a, 15b are always located in the first sub-winding zone 22a, the shaped conductors 4 of the second arrangement 16b of a respective path 15a, 15b are always located in the second sub-winding zone 22b and the shaped conductors 4 of the third arrangement 16c of a respective path 15a, 15b are always located in the third sub-winding zone 22c.

In the present exemplary embodiment, provision is moreover made for the lap windings of the first path 15a to be formed in such a pair of adjacent first and second winding zones 21a, 2b in which two adjacent lap windings of the second path 15b are connected by a wave winding.

As is further clear from FIG. 3, the groups of the first type 17a-c of a respective arrangement 16a of the first path 15a and the groups of the second type 18a-c are designed to be identical with regard to the layer 19a-f of the receiving space receiving the shaped conductors 4. This means that the receiving space of the shaped conductors only differs in terms of the sub-winding zone 22a-c.

FIG. 4 is a sub-winding diagram of the groups of the first type 17a-c.

The groups of the first type 17a each comprise six shaped conductors 4, specifically a first shaped conductor 24a, a second shaped conductor 24b, a third shaped conductor 24c, a fourth shaped conductor 24d, a fifth shaped conductor 24e and a sixth shaped conductor 24f. These are numbered in accordance with their order in the series connection from the first outer shaped conductor 23a to the second outer shaped conductor 24b (see FIG. 3).

The first shaped conductor 24a of a respective one of the groups of the first type 17a-c is arranged in the fifth layer 19e of one of the first winding zones 21a. The second shaped conductor 24b of a respective one of the groups of the first type 17a-c is arranged in the sixth layer 19f of a second winding zone adjacent to the first of the winding zones 21 along the first orientation 20a. The third shaped conductor 24c of a respective one of the groups of the first type 17a-c is arranged in the fourth layer 19d of the first winding zone 21a. The fourth shaped conductor 24d of a respective one of the groups of the first type 17a-c is arranged in the third layer 19c of the second winding zone 21b. The fifth shaped conductor 24e of a respective one of the groups of the first type 17a-c is arranged in the first layer 19a of the first winding zone 21a. The sixth shaped conductor 24f of a respective one of the groups of the first type 17a-c is arranged in the second layer 19b of the second winding zone 21b. The first to sixth shaped conductor 24a-f are therefore arranged in a zigzag pattern and form two loops of the combined lap and wave winding.

It is further clear from FIG. 4 that the first shaped conductor 24a and the second shaped conductor 24b, the third shaped conductor 24c and the fourth shaped conductor 24d, and the fifth shaped conductor 24e and the sixth shaped conductor 24f are each connected to each other by a connector of the second type 10, which realizes an offset of q·N=9 slots 3. The second shaped conductor 24b and the third shaped conductor 24c and the fourth shaped conductor 24d are each connected to each other by a connector of the first type 8, which realizes an offset of q·N−1=8 slots 3 If a first shaped conductor 24a of a following group of the first type 17a-c, in terms of the series connection, in turn adjoins the sixth shaped conductor 24f, which applies to all groups of the first type 17a-c apart from the last group of the first type 17c of the third arrangement 16c, the sixth shaped conductor 24f and the first shaped conductor 24a are connected by a connector of the first type 8. This connector of the first type 8 realizes an offset of q·N−2=7 slots 3 if the sixth shaped conductor 24f and the first shaped conductor 24a belong to the same arrangement 16a-c, or an offset of q·N−3=6 slots 3 if the sixth shaped conductor 24f and the first shaped conductor 24a belong to different arrangements 16a-c.

FIG. 5 is a sub-winding diagram of the groups of the second type 18a-c.

The groups of the second type 18a each comprise six shaped conductors 4, specifically a first shaped conductor 25a, a second shaped conductor 25b, a third shaped conductor 25c, a fourth shaped conductor 25d, a fifth shaped conductor 25e and a sixth shaped conductor 25f. These are numbered in accordance with their order in the series connection from the first outer shaped conductor 23a to the second outer shaped conductor 24b (see FIG. 3).

The first shaped conductor 25a of a respective one of the groups of the second type 18a-c is arranged in the sixth layer 19f of one of the first winding zones 21a. The second shaped conductor 25b of a respective one of the groups of the second type 18a-c is arranged in the fifth layer 19e of a following second winding zone 21b along the second orientation 20b. The third shaped conductor 25c of a respective one of the groups of the second type 18a-c is arranged in the second layer 19b of a following first winding zone 21a along the second orientation 20b. The fourth shaped conductor 25d of a respective one of the groups of the second type 18a-c is arranged in the first layer 19a of a following second winding zone 21b along the second orientation 20b. The fifth shaped conductor 25e of a respective one of the groups of the second type 18a-c is arranged in the third layer 19c in the same first winding zone 21a as the third shaped conductor 25c. The sixth shaped conductor 25f of a respective one of the groups of the second type 18a-c is arranged in the fourth layer 19d in the same second winding zone 21b as the fourth shaped conductor 25d. The connectors of the first type 8, which connect the second shaped conductor 25b and the third shaped conductor 25c, form a wave component of the combined lap and wave winding here.

It is further clear from FIG. 5 that the first shaped conductor 25a and the second shaped conductor 25b, the third shaped conductor 25c and the fourth shaped conductor 25d, and the fifth shaped conductor 25e and the sixth shaped conductor 25f are each connected to each other by a connector of the second type 10, which realizes an offset of q·N=9 slots 3. The second shaped conductor 25b and the third shaped conductor 25c are connected to each other by a connector of the first type 8, which realizes an offset of q·N−2=7 slots 3 The fourth shaped conductor 25d and the fifth shaped conductor 25e are connected to each other by a connector of the first type 8, which realizes an offset of q·N−1=8 slots 3. If a first shaped conductor 25a of a following group of the second type 18a-c, in terms of the series connection, in turn adjoins the sixth shaped conductor 25f, which applies to all groups of the second type 18a-c apart from the last group of the second type 18c of the third arrangement 16c, the sixth shaped conductor 25f and the first shaped conductor 25a are connected by a connector of the first type 8. This connector realizes an offset of q N−1=8 slots 3 if the sixth shaped conductor 24f and the first shaped conductor 24a belong to the same arrangement 16a-c or an offset of q·N−2=7 slots 3 if the sixth shaped conductor 24f and the first shaped conductor 24a belong to different arrangements 16a-c.

FIG. 6 is a basic diagram of a plurality of conductor segments 26a-c according to the first exemplary embodiment.

The conductor segments 26a, 26b are each formed from two shaped conductors 4, a connector of the first type 8, which adjoins the second shaped conductors 4 at the first end side 7 and connects them, and two connecting elements 11a, 11b, which adjoin a respective one of the two shaped conductors 4 at the second end side 9. Here, the conductor segments 26a, 26b are formed in one piece by way of example, but alternatively can also be formed by joining separate components. In each case two connecting elements 11a, 11b of different conductor segments 26a, 26b form a connector of the second type 10.

In the conductor segment 26a, the connecting elements 11a, 11b point towards each other in contrary orientations 20a, 20b. The connected second and third shaped conductors 24b, 24c of a respective group of the first type 17a-c, the connected fourth and fifth shaped conductors 24d, 24e of a respective group of the first type 17a-c, the connected fourth and fifth shaped conductors 25d, 25e of a respective group of the second type 18a-c and mutually connected sixth and first shaped conductors 25f, 25a of different groups of the second type 18a-c are formed by conductor segments 26a.

In the conductor segment 26b, the conducting elements 11a, 11b point away from each other in contrary orientations 20a, 20b. The connected second and third shaped conductors 25b, 25c of a respective group of the second type 18a-d and mutually connected sixth and first shaped conductors 24f, 24a of different groups of the first type 17a-c are formed by conductor segments 26b.

The conductor segment 26c comprises a shaped conductor 4, a connecting element 11a adjoining the shaped conductor 4 at the second end side 9 and a connection element 28 for making contact with the connection device 12 (see FIG. 1). The first outer shaped conductor 23a, that is to say the first shaped conductor 24a of the first group 17a of the first arrangement 16a of the first path 15a and the first shaped conductor 25a of the first arrangement 16a of the second path 15b, and the second outer shaped conductor 23b, that is to say the sixth shaped conductor 24f of the last group 17c of the third arrangement 16c of the first path 15a and the sixth shaped conductor 25f of the last group 18c of the third arrangement 16c of the second path 15b are formed by conductor segments 26c.

FIG. 6 schematically shows the conductor segments 26a-c, in particular without precise illustration of the number of slots 3 by which the connectors of the first type 10, 10a, 10b or the connecting elements 11a, 11b realize an offset. The conductor segments 26a, 26b can also be regarded as U-pins or hairpin conductors and the conductor segments 26c can be regarded as I-pins. The entire stator winding is then also referred to as a hairpin winding.

FIG. 7 is a winding diagram according to a second exemplary embodiment of the stator 1. Identical or functionally equivalent components are provided with identical reference signs here. Only the essential differences with respect to the first exemplary embodiment are represented below.

The stator 1 according to the second exemplary embodiment has P=4 pole pairs. In particular, this results in a total number of 72 slots 3. As a result of the increased pole pair count, four groups of the first type 17a-d are provided in each arrangement 16a-c of the first path 15a and four groups of the second type 18a-d are provided in each arrangement 16a-c of the second path 15b.

FIG. 8 is a winding diagram according to a third exemplary embodiment of the stator 1. Identical or functionally equivalent components are provided with identical reference signs here. Only the essential differences with respect to the first exemplary embodiment are represented below.

In the third exemplary embodiment of the stator 1, only the first layer 19a and the second layer 19b of a respective winding zone 21 are offset with respect to the third layer 19c and the fourth layer 19d by one slot 3. The fifth layer 19e and the sixth layer 19f of a respective winding zone 21 are located in the same slots 3 as the third layer 19c and the fourth layer 19d.

The result of this, in particular, is that the connectors of the second type 10, which connect the first shaped conductor 24a and the second shaped conductor 24b, the third shaped conductor 24c and the fourth shaped conductor 24d, and the fifth shaped conductor 24e and the sixth shaped conductor 24f of a respective group of the first type 17a-c, realize an offset of q·N=9 slots 3, as in the first exemplary embodiment. The connectors of the first type 8 which connect the second 24b shaped conductor and the third shaped conductor 24c of a respective group of the first type 17a-c realize an offset of q·N=9 slots 3. The connectors of the first type 8 which connect the fourth shaped conductor 24d and the fifth shaped conductor 24e of a respective group of the first type 17a-c realize an offset of q·N−1=8 slots 3. The connectors of the first type 8 which connect a sixth shaped conductor 24f to a first shaped conductor 24a of the same arrangement 16a-c realize an offset of q·N−1=8 slots 3. The connectors of the first type 8 which connect a sixth shaped conductor 24f to a first shaped conductor 24a of different arrangements 16a-c realize an offset of q·N=−2=7 slots 3.

The connectors of the second type 10, which connect the first shaped conductor 25a and the second shaped conductor 25b, the third shaped conductor 25c and the fourth shaped conductor 25d, and the fifth shaped conductor 25e and the sixth shaped conductor 25f of a respective group of the second type 18a-c, further realize an offset of q·N=9 slots 3, as in the first exemplary embodiment. The connectors of the first type 8 which connect the second shaped conductor 25b and the third shaped conductor 25c of a respective group of the second type 18a-c, and the connectors of the first type 8 which connect the second shaped conductor 25b and the third shaped conductor 25c of a respective group of the second type 18a-c realize an offset of q·N−1=8 slots 3. The connectors of the first type 8 which connect a sixth shaped conductor 25f to a first shaped conductor 25a of the same arrangement 16a-c realize an offset of q·N−1=9 slots 3. The connectors of the first type 8 which connect a sixth shaped conductor 25f to a first shaped conductor 25a of different arrangements 16a-c realize an offset of q·N−1=8 slots 3.

FIG. 9 is a winding diagram according to a fourth exemplary embodiment of the stator 1. Identical or functionally equivalent components are provided with identical reference signs here. Only the essential differences with respect to the first exemplary embodiment are represented below.

The stator 1 according to the fourth exemplary embodiment has P=4 pole pairs. In particular, this results in a total number of 72 slots 3. As a result of the increased pole pair count, four groups of the first type 17a-d are provided in each arrangement 16a-c of the first path 15a and four groups of the second type 18a-d are provided in each arrangement 16a-c of the second path 15b.

FIG. 10 is a block circuit diagram of the stator winding according to further exemplary embodiments of the stator 1. Here, the outer shaped conductors 23b of the first paths 15a are interconnected to form a first star point 14a and the outer shaped conductors 23b of the second paths 15b are interconnected to form a second star point 14b.

FIG. 11 is a block circuit diagram of the stator winding according to further exemplary embodiments of the stator 1. Here, in a respective phase U, V, W, the second outer shaped conductor 23b of the first path 15a is connected in series to the first outer shaped conductor 23a of the second path 15b and the second outer shaped conductors 23b of a respective second path 15b are interconnected to form a star point 14.

Moreover, the exemplary embodiments according to FIGS. 10 and 11 correspond to one of the previously described exemplary embodiments.

According to further exemplary embodiments, which moreover correspond to the first or third exemplary embodiment, the stator 1 has only P=2 pole pairs, so that only two groups of the first type 17a, 17b or two groups of the second type 18a, 18b are provided in a respective arrangement 16a-c, and only 36 slots 3.

According to further exemplary embodiments, which moreover correspond to one of the previously described exemplary embodiments, the first layer 19a is the radially outermost layer and the sixth layer 19f is the radially innermost layer.

FIG. 12 is a basic diagram of a vehicle 100 having an exemplary embodiment of an electric machine 101, for example a synchronous machine or an asynchronous machine/induction machine, which is designed as an electric motor. The electric machine 101 comprises a stator 1 according to one of the previously described exemplary embodiments and a rotor 102 which is rotatably mounted within the stator 1. In the present exemplary embodiment, the rotor 102 is permanently excited, by way of example.

1. A stator for an electric machine, wherein
the stator has a number N of phases, a number P of pole pairs and a number of holes q, wherein N≥3 and P≥2 and q=3, wherein
the stator comprises a stator core having a plurality slots and a plurality shaped conductors, which are arranged in the slots so as to be radially layered in a first to Lth layer, wherein L=6 and the layers are numbered in their order in the radial direction, wherein
the shaped conductors of each phase form a first path and second path, which can be or are interconnected in series or in parallel with each other and are arranged in P first winding zones and P second winding zones, wherein the first and second winding zones alternate in the circumferential direction and each winding zone extends over the L layers, wherein a first orientation and a second orientation which is opposed to the first orientation of the circumferential directions are defined, wherein
the shaped conductors of a respective path are interconnected to form a series connection having a first outer shaped conductor in terms of the series connection and a second outer shaped conductor in terms of the series connection, by connectors, which connect shaped conductors in adjacent winding zones of the same phase in an alternating manner at a first end side and a second end side opposite the first end side of the stator core, wherein
the first and second layer of a respective winding zone are offset with respect to the third and fourth layer of the respective winding zone by one slot in the circumferential direction, wherein
the paths each form a combined lap and wave winding.

2. The stator as claimed in claim 1, wherein
The first outer shaped conductor of the first path is arranged in one of the first winding zones and the first outer shaped conductor of the second path is arranged in one of the first winding zones, in particular in the same first winding zone in which the first outer shaped conductor of the first path is arranged.

3. The stator as claimed in claim 1, wherein
each winding zone is subdivided into a first to qth sub-winding zone, each sub-winding zone extends over the L layers and the sub-winding zones of a respective winding zone are numbered in their order in the circumferential direction.

4. The stator as claimed in claim 3, wherein
each path is subdivided into q series-connected arrangements of series-connected shaped conductors and each arrangement occupies all winding zones of the phase q-times, wherein the shaped conductors of a respective arrangement are arranged in the same sub-winding zone.

5. The stator as claimed in claim 3, wherein
the first outer shaped conductor of a respective path is arranged in the first sub-winding zone and/or the second outer shaped conductor of a respective path is arranged in the third sub-winding zone.

6. The stator as claimed in claim 1, wherein
the first path extends from its first outer shaped conductor to its second outer shaped conductor along the first orientation and the second path extends from its first outer shaped conductor to its second outer shaped conductor along the second orientation.

7. The stator as claimed in claim 1, wherein
the first and second layer of a respective winding zone is offset with respect to the third and fourth layer along the first orientation.

8. The stator as claimed in claim 1, wherein
the fifth and sixth layer of a respective winding zone are offset with respect to the third and fourth layer of the respective winding zone by one slot in the circumferential direction, in particular in the contrary orientation to the offset of the first and second layer.

9. The stator as claimed in claim 1, wherein
the first path is formed from a plurality of series-connected groups of six successive shaped conductors, in terms of the series connection, which are arranged in one of the first winding zones and a second winding zone adjacent thereto along the first orientation, wherein
a first shaped conductor of a respective one of the groups is arranged in the fifth layer of the first winding zones,
a second shaped conductor of a respective one of the groups is arranged in the sixth layer of the second winding zone,
a third shaped conductor of a respective one of the groups is arranged in the fourth layer of the first winding zone,
a fourth shaped conductor of a respective one of the groups is arranged in the third layer of the second winding zone,
a fifth shaped conductor of a respective one of the groups is arranged in the first layer of the first winding zone, and
a sixth shaped conductor of a respective one of the groups is arranged in the second layer of the second winding zone,
wherein the first shaped conductor to sixth shaped conductor are numbered in their order in terms of the series connection, wherein
the first shaped conductor of such groups, which directly follows a sixth shaped conductor of another group in terms of the series connection, is arranged in that first winding zone which follows the sixth shaped conductor of the other of the groups along the first orientation.

10. The stator as claimed in claim 1, wherein
the second path is formed from a plurality of series-connected groups of six successive shaped conductors, in terms of the series connection, which are arranged in four successive winding zones,
a first shaped conductor of a respective one of the groups is arranged in the sixth layer of one of the first winding zones,
a second shaped conductor of a respective one of the groups is arranged in the fifth layer a following second winding zone along the second orientation,
a third shaped conductor of a respective one of the groups is arranged in the second layer of a following first winding zone along the second orientation,
a fourth shaped conductor of a respective one of the groups is arranged in the first layer of a following second winding zone along the second orientation,
a fifth shaped conductor of a respective one of the groups is arranged in the third layer in the same first winding zone as the third shaped conductor and
a sixth shaped conductor of a respective group is arranged in the fourth layer in the same second winding zone as the fourth shaped conductor,
wherein the first shaped conductor to sixth shaped conductor are numbered in their order in terms of the series connection,
wherein the first shaped conductor of such groups, which directly follow a sixth shaped conductor of another of the groups in terms of the series connection, is arranged in the same first winding zone as the fifth shaped conductor of the other of the groups.

11. The stator as claimed in claim 1, wherein
the connectors are designed alternately as connectors of a first type, which are arranged on a first end side of the stator core, and as connectors of a second type, which are arranged on a second end side opposite the first end side of the stator core.

12. The stator as claimed in claim 11, wherein
the connectors of the first type are formed in one piece with the shaped conductors connected by them and extend out of the stator core at the first end side and/or
the connectors of the second type comprise two connecting elements, which, at the second end side, extending out of the stator core, adjoin the shaped conductors connected by the connector of the second type and are electrically conductively connected to each other, in particular in an integrally bonded manner.

13. The stator as claimed in claim 11, wherein
the connectors of the second type connect pairs of directly successive shaped conductors, in terms of the series connection,
in the first layer and the second layer and/or
in the third layer and the fourth layer and/or
in the fifth layer and the sixth
layer.

14. The stator as claimed in claim 1, further comprising
a connection device with phase connections and at least one star point, which
connects the paths of a respective phase (U, V, W) in parallel such that the first outer shaped conductors are connected to the phase connections and the second outer shaped conductors are connected to form a star point or to form two star points or in that the second outer shaped conductors are connected to the phase connections and the first outer shaped conductors are connected to form a star point or two star points, or
the paths of a respective phase are connected in series such that one of the outer shaped conductors of one of the paths is connected to the phase connections and one of the outer shaped conductors of the other of the paths is connected to the star point.

15. An electric machine for driving a vehicle, comprising a stator as claimed in claim 1 and a rotor rotatably mounted within the stator.

16. The stator as claimed in claim 2, wherein
each winding zone is subdivided into a first to qth sub-winding zone, each sub-winding zone extends over the L layers and the sub-winding zones of a respective winding zone are numbered in their order in the circumferential direction.

17. The stator as claimed in claim 4, wherein
the first outer shaped conductor of a respective path is arranged in the first sub-winding zone and/or the second outer shaped conductor of a respective path is arranged in the third sub-winding zone.

18. The stator as claimed in claim 2, wherein
the first path extends from its first outer shaped conductor to its second outer shaped conductor along the first orientation and the second path extends from its first outer shaped conductor to its second outer shaped conductor along the second orientation.

19. The stator as claimed in claim 2, wherein
the first and second layer of a respective winding zone is offset with respect to the third and fourth layer along the first orientation.

20. The stator as claimed in claim 2, wherein
the fifth and sixth layer of a respective winding zone are offset with respect to the third and fourth layer of the respective winding zone by one slot in the circumferential direction, in particular in the contrary orientation to the offset of the first and second layer.
